(19) United States
(12) Patent Application Publication
(10) Pub. No.: US 2014/0014498 A1
(43) Pub. Date: Jan. 16, 2014

(54) METHOD FOR MANUFACTURING METAL FOIL PROVIDED WITH ELECTRICAL RESISTANCE LAYER

(71) Applicant: Toshio Kurosawa, Hitachi-shi (JP)

(72) Inventor: Toshio Kurosawa, Hitachi-shi (JP)

(73) Assignee: JX Nippon Mining & Metals Corporation, Hitachi-shi, Ibaraki (JP)

(21) Appl. No.: 14/008,109

(22) PCT Filed: Mar. 28, 2012
(86) PCT No.: PCT/JP2012/058204

§ 371 Date: Sep. 27, 2013

(30) Foreign Application Priority Data
Mar. 31, 2011 (JP) 2011-077798

(51) Int. Cl. H01C 17/12

(52) U.S. Cl. CPC H01C 17/12
USPC 204/192.11

(57) ABSTRACT

The present invention provides a method for producing a metal foil with an electric resistance layer which can stably obtain electric characteristics of a resistive element, suppress peeling between the metal foil and the electric resistance layer disposed on the metal foil, and realize a high sheet resistance value and the method includes forming an electric resistance layer on a metal foil having a 10-point average roughness Rz, which is measured by the optical method according to 1 μm or less and whose surface is treated by irradiation with ion beams at an ion beam intensity of 0.70 to 2.10 sec·W/cm² by vapor deposition while applying oxygen as an atmospheric gas using a sputtering target containing nickel, chromium, and silicon.

### TECHNICAL FIELD

The present invention relates to a method for producing a metal foil with an electric resistance layer, for example, a method for producing a metal foil with an electric resistance layer which can be used as a resistive element mountable on the surface or to the inside of a circuit board.

### BACKGROUND ART

In recent years, proposals have been made for additionally forming a thin film made of an electric resistance material (electric resistance layer) on a copper foil as a wiring material (refer to, for example, Patent Literatures 1 and 2). An electric resistive element may be essential in an electronic circuit board, and, if a copper foil comprising a resistive layer is used, a resistive element can be formed by etching the electric resistance layer formed on the copper foil. As a result of building the resistor into the substrate, the limited surface area of the substrate can be effectively used in comparison to conventional methods of having to mount a chip resistive element on the surface of the substrate with solder bonding. As the electric resistance layer, a resistor of a metal material such as NiCr was conventionally used to obtain a sheet resistance value of about 10 to 250 ohm/sq.

However, in recent years, there has been a need for a resistance value higher than a sheet resistance value which can be achieved using the conventional metal material such as NiCr. When the conventional metal material such as NiCr is used, influences of an etching solution when forming a resistive element and etching selectivity may be caused. Alternatively, when a high temperature treatment such as soldering reflow after formation of the resistive element is performed, the strength may be decreased and the sheet resistance value of the resistive element finally obtained may be largely shifted from a desired value. Consequently, sufficient reliability may not be obtained.

Further, when a resistive layer is formed on the surface of a metal foil such as a copper foil to form a resistive element, it is necessary to improve the adhesive strength to the extent that peeling is not caused at least between the resistive layer and the metal foil. Generally, the adhesion between the metal foil and the resistive layer is improved as the surface roughness of the surface of the metal foil becomes coarse. Thus, the surface of the metal foil was conventionally subjected to surface treatment such as roughening treatment to increase the surface roughness.

However, if the surface roughness of the metal foil is increased too much, variations in the resistance value of the resistive layer formed on the metal foil become larger. Particularly, when the resistive layer is formed into a thin film, even if a uniform filmy resistive layer is formed on the surface of a coarse metal foil by, for example, sputtering, variations in the resistance value become larger due to the surface roughness. As a result, it becomes difficult to stably obtain desired electric characteristics of the resistive element.

### CITATION LIST

### Patent Literatures

Patent Literature 1: Japanese Patent No. 3311338

Patent Literature 2: Japanese Patent No. 3452557

### SUMMARY OF INVENTION

### Problem to be Solved by the Present Invention

In view of the above described problems, the present invention provides a method for producing a metal foil with an electric resistance layer which can stably obtain electric characteristics of a resistive element, suppress peeling between the metal foil and the electric resistance layer disposed on the metal foil, and realize a high sheet resistance value.

### Means for Solving the Problem

As a result of the present inventor has conducted intensive studies to solve the above problems, the inventor has found that it is effective to use an appropriate material having a particular resistance value higher than that of the conventional metal alloy layer such as NiCr as an electric resistance layer on an appropriate metal foil as a sputtering target, and apply oxygen as an atmospheric gas during production of the electric resistance layer.

Further, the present inventor has conducted intensive studies on surface characteristics of the metal foil to be disposed on the electric resistance layer. The inventor has found that when a metal foil having a surface roughness lower than that of the conventional one is employed, the metal foil which is resulted from performing surface treatment thereon without adjusting the surface having a particular range of surface roughness (for example, Rz of 6 to 8 μm) as the conventional roughening treatment, it is possible to simultaneously achieve the suppression of peeling between the metal foil and the resistive layer and the reduction of variations in the resistance value of the resistive layer.

In one aspect, the present invention completed on the basis of the findings includes forming an electric resistance layer on a metal foil having a 10-point average roughness Rz, which is measured by the optical method, of 1 μm or less and whose surface is treated by irradiation with ion beams at an ion beam intensity of 0.70 to 2.10 sec·W/cm² by vapor deposition while applying oxygen as an atmospheric gas using a sputtering target containing nickel, chromium, and silicon.

According to one embodiment of the method for producing a metal foil with an electric resistance layer of the present invention, the forming an electric resistance layer includes controlling the amount of oxygen as an atmospheric gas so that the oxygen concentration in the electric resistance layer is from 20 to 60 at %.

According to another embodiment of the method for producing a metal foil with an electric resistance layer of the present invention, the sputtering target includes a NiCrSi alloy or a NiCrSiO alloy.

According to another embodiment of the method for producing a metal foil with an electric resistance layer of the present invention, a sputtering target in which the Ni-content is from 2 to 10 at %, and the Cr-content is from 73 to 79 at % and the O-content is from 10 to 60 at % in a component percentage of Cr and Si (Cr/(Cr+Si)×100[%]) is used.

According to another embodiment of the method for producing a metal foil with an electric resistance layer of the present invention, the method includes applying 0 to 19 vol % of oxygen as the atmospheric gas.

According to another embodiment of the method for producing a metal foil with an electric resistance layer of the present invention, the method further includes providing a thermoplastic resin layer on the electric resistance layer.

According to another embodiment of the method for producing a metal foil with an electric resistance layer of the present invention, the metal foil is an electrolytic copper foil or a rolled copper foil.

According to the present invention, there can be provided a method for producing a metal foil with an electric resistance layer which can stably provide electric characteristics of a resistive element, suppress peeling between the metal foil and the electric resistance layer disposed on the metal foil, and realize a high sheet resistance value.

### DESCRIPTION OF EMBODIMENTS

The method for producing a metal foil with an electric resistance layer according to an embodiment of the invention includes forming an electric resistance layer on a metal foil whose surface is treated so that the 10-point average roughness Rz measured by the optical method is adjusted to 1 μm or less by vapor deposition while applying oxygen as an atmospheric gas using a sputtering target containing nickel, chromium, and silicon.

As the metal foil, for example, an electrolytic copper foil or a rolled copper foil can be used. The term “copper foil” of the present embodiment refers to a copper alloy foil, in addition to the copper foil. When the electrolytic copper foil is used as the metal foil, it can be produced by using a general electrolytic device. However, in the present embodiment, it may be preferable to select an appropriate additive which is added in an electrolytic process, stabilize the drum rotation speed, and form an electrolytic copper foil having a uniform surface roughness and a uniform thickness. The thickness of the metal foil is not particularly limited; however, for example, a metal foil having a thickness of 5 to 70 μm, particularly a thickness of 5 to 35 μm can be used.

It is preferable that at least one of the surfaces of the metal foil is a surface in which the 10-point average roughness Rz measured by the optical method is adjusted to 1 μm or less. Here, the treated surface in which “the 10-point average roughness Rz measured by the optical method is 1 μm or less and variations in the 10-point average roughness Rz are within ±5%” refers to a surface having a resolution of 0.2 μm×0.2 μm or less and a 10-point average roughness Rz obtained when measured with an optical interferotype optical surface shape measurement device.

Namely, the 10-point average roughness Rz is defined as a value in micrometers (μm) determined by taking only a reference length out in the direction of an average line from a part of roughness curve which is obtained with an optical interferotype optical surface shape measurement device, and calculating the sum of the average of absolute values of altitudes of the highest five peaks and the average of absolute values of altitudes of the lowest five bottoms measured from the average line of the taken out part in the longitudinal magnification direction.

The use of this measurement method allows the correlation between the surface roughness of the surface of the metal foil and the resistance value of the resistive layer to be specifically grasped. In other words, according to this measurement method, it is possible to evaluate the fact that the resistance value of the resistive layer tends to be increased linearly as the average roughness Rz is increased within a predetermined range. Therefore, when manufacturers control the average roughness Rz of the resistive layer depending on a target electric resistance value, a resistive layer having a desired electric resistance value can be stably produced.

As the optical interferotype optical surface shape measurement device, a non-contact three-dimensional surface shape roughness measurement system, product number NT1100 (WYKO optical profiler; resolution: 0.2 μm×0.2 μm or less; manufactured by Veeco) can be used. The measurement method for this system is Vertical Scan Interferometry (VSI method), and its visual field is 120 μm×90 μm, and its measurement scan density is 7.2 μm/sec. The interferometry is the Mirau interferometry (objective lens: 50×, internal lens: 1×).

In the present embodiment, if the roughness Rz of the metal foil is 1 μm or less, sufficient adhesion strength can be obtained; however, even if the roughness Rz is 0.5 μm or less, or 0.4 μm or less, the effect of the present embodiment can be sufficiently exerted. The lower limit of the roughness Rz may be not particularly limited; however the roughness Rz can be 0.1 nm or more, for example.

The surface of the metal foil is subjected to surface treatment for cleaning. As a specific surface treatment means, ion beam irradiation is preferably performed. The surface of the metal foil is irradiated with ion beams to achieve cleaning of the surface. Thus, the adhesion strength between the metal foil and the resistive layer disposed on the upper surface is improved.

If the ion beam irradiation amount is too small, the adhesion strength may not be sufficiently obtained. On the contrary, when the amount is too large, the power consumption is increased, resulting in a decrease in productivity. For example, it is preferable that the ion beam intensity may be from 0.70 to 2.10 sec·W/cm², more preferably from 0.78 to 1.50 sec·W/cm²; however, there is no limitation to the conditions. The “ion beam intensity (sec·W/cm²)” to be described in the present embodiment is calculated by the following formula:

Treating time (sec)×ion beam voltage (V)×current (A)/treating area (cm²)

The electric power when irradiating the metal foil with ion beams is 0.78 (sec·W/cm²)×35 (cm)×1.08 (cm/sec)=29.5 (W), when, for example, the product width is 35 cm and the line speed is 0.65 m/min (=1.08 cm/sec). If the ion beam electric power is about 30 W or more, it is a sufficient irradiation amount.

After performing the surface treatment of the metal foil, an electric resistance layer is formed on the surface of the metal foil after the surface treatment by the gas-phase reaction method. As the gas-phase reaction method, the physical gas-phase reaction method using a sputtering device is suitably used. When the sputtering device is used, the metal foil and the sputtering target are placed in the vacuum chamber of the sputtering device.

As the sputtering target material, it is preferable to use a metal material exhibiting a particular resistance value higher than that of a NiCr alloy when the electric resistance layer is formed. For example, a sputtering target containing nickel (Ni), chromium (Cr), and silicon (Si) can be used. As the sputtering target material containing Ni, Cr, and Si, for example, a NiCrSi alloy and an NiCrSiO alloy can be used; however, there is no limitation thereto. The use of the sputtering target material containing Ni, Cr, and Si allows the high resistance of the electric resistance layer to be obtained and the reduction in variations in sheet resistance value to be achieved as compared with when the NiCr alloy or the NiSiO alloy is used as the sputtering target material, and the strength of the electric resistance layer can be improved.

Further, in the present embodiment, the amount of oxygen supply at the time of forming the electric resistance layer can be adjusted so that the concentration of oxygen in the electric resistance layer is adjusted to a suitable range and the particular resistance value of the electric resistance layer is controlled. Accordingly, the specific composition of the sputtering target material is not particularly limited. A metal target or an oxide target may be used, and thus various sputtering target materials can be used. According to the present invention, an electric resistance layer having a desired particular resistance value can be formed without changing the sputtering target material. This leads to an improvement in production efficiency.

For example, when the NiCrSiO alloy is used as the sputtering target material, it is preferable to use a material in which the Ni-content is from 2 to 10 at % (atomic %), and the Cr-content is from 73 to 79 at % and the O-content is from 10 to 60 at % in a component percentage of Cr and Si (Cr/(Cr+Si)×100[%]), more preferably, the Ni-content is from 2 to 5 at %, and the Cr-content is 76 at % and the O-content is from 10 to 60 at % in a component percentage of Cr and Si (Cr/(Cr+Si)×100[%]). However, there is no limitation thereto.

As atmospheric gases, an inert gas and a reactive gas are supplied to a vacuum chamber. As the inert gas, an argon (Ar) gas, a nitrogen (N₂) gas, or the like is preferred. As the reactive gas, an oxygen gas is used.

The oxygen gas is preferably controlled so that the finally obtained concentration of oxygen in the electric resistance layer is from 20 to 60 at %. The term “concentration of oxygen in the electric resistance layer” refers to the concentration of oxygen when the surface of the electric resistance layer is subjected to argon spattering for about several minutes, and the concentration of oxygen of the electrode surface (a depth of about several nm) is measured by X-ray photoelectron spectroscopy. When the concentration of oxygen in the electric resistance layer is lower than 20 at%, the sheet resistance value of the electric resistance layer may not be significantly improved. On the other hand, when the concentration of oxygen in the electric resistance layer is greater than 60 at%, the electric resistance layer becomes a transparent glass layer. Thus, desired characteristics may not be obtained.

For example, when the electric resistance layer is vapor-deposited using an NiCrSiO alloy containing 4 at % of Ni, 60 at % of Cr, and 36 at % of SiO as the sputtering target, the concentration of oxygen in the electric resistance layer can be controlled to 20 to 60 at % by introducing oxygen at a ratio of oxygen in a gas from 0 to 19 vol %, preferably about 2 to 17 vol % into the vacuum chamber; however, there is no limitation thereto.

If the concentration of oxygen to be introduced when sputtering varies, variations in the sheet resistance value of the electric resistance layer may become large. Thus, it is preferable to exactly control the amount of oxygen to be applied into the vacuum chamber at the time of sputtering. For example, in order to make variations in the sheet resistance value of the electric resistance layer within ±5%, the displacement of the concentration of oxygen in the vacuum chamber is preferably controlled so as to be within 0.5%, more preferably within 0.3%. As for the concentration control, the concentration can be controlled to about ±0.1% by using, for example, a mass flow controller.

A thermoplastic resin may be further placed on the electric resistance layer. As the thermoplastic resin layer, for example, an epoxy-based bonding sheet to be applied to a circuit board, a polyimide-based bonding sheet, a glass epoxy-based bonding sheet, a bonding film or a primer (coating material) containing polyimide and epoxy resin is suitably used. The method for forming a thermoplastic resin layer is not particularly limited. For example, a sheet or a film in solid form is superimposed between the surface of the metal foil and the electric resistance layer and they are joined by thermocompression bonding. Alternatively, the surface of the metal foil is coated with a liquid primer and dried, followed by joining by thermocompression bonding. The thickness of the thermoplastic resin layer is not particularly limited; however, if at least a resin layer having a thickness of 1 μm or more is formed, the bonding strength can be improved. The thickness of the resin layer is more preferably from 5 to 50 μm.

When the metal foil with an electric resistance layer according to the embodiment of the invention is incorporated into the circuit board, for example, the side of the electric resistance layer of the metal foil with an electric resistance layer is brought into contact with the top surface of the circuit board, and the circuit board and the metal foil with an electric resistance layer are joined by thermocompression bonding or the like. Then, the metal foil is spin-coated with a photoresist film, followed by patterning using a photolithography technique. Subsequently, some of the metal foil and the electric resistance layer are removed using the photoresist film patterned by reactive ion etching (RIE) or the like as an etching mask and the photoresist film is removed. The top surface of the metal foil remained on the circuit board is further spin-coated with a photoresist film, followed by patterning into a shape in accordance with the length and surface area of the resistive element using the photolithography technique. The metal foil is removed using the patterned photoresist film as an etching mask. The photoresist film is removed to form a resistive element on the circuit board. Thereafter, an insulating layer and a wiring layer are formed on the resistive element by a known multi-layer wiring technique so that the resistive element can be embedded in the circuit board.

### Other Embodiment

The described embodiments of the present invention as described above, but the descriptions and the drawings constituting parts of this disclosure should not be understood as limiting the present invention. From this disclosure, various alternative embodiments and operational technologies will become apparent to those skilled in the art. For example, in order to further improve the adhesion between the electrolytic foil and the electric resistance layer, an optional alloy layer (a copper-zinc alloy layer and a stabilization layer) as disclosed in, for example, Japanese Patent Application Laid-open No. 2009-503343 may be formed on the electrolytic foil. As described above, of course, the present invention encompasses various embodiments that are not described herein. Modifications can be achieved without departing from the spirit of the invention in practical phase.

### EXAMPLES

Hereinafter, Examples of the present invention will be described; however, the present invention does not intend to be limited to the following examples.

Evaluation of Strength of Interface Between Electric Resistance Layer (NiCrSiO Alloy) and Metal Foil

Samples shown in the following examples and comparative examples were produced using the Vaccume WEB Chamber manufactured by CHA (14-inch width) having an ion beam source as the pretreatment of the spattering of the electric resistance layer. As the ion beam source, a Kaufman type ion beam source (6.0 cm×40 cm Linear Ion Source, manufactured by ION TECH INC) was used. The power source of the ion beam source is the ion source (MPS-5001, ION TECH INC) and the maximum power output of ion beams is about 3 W/cm².

A 18-μm-thick electrolytic copper foil was prepared. The 10-point average roughness Rz, which is measured by the optical method, of the surface (roughened surface) of the metal foil was 0.51 μm. The roughened surface of the electrolytic copper foil was subjected to surface treatment by using the above sputtering device and adjusting the line speed, the IB voltage, and the IB current to the conditions shown in Table 1. The ion beam intensities of Comparative examples 1 to 3 and Examples 1 to 4 are 0.24 sec·W/cm² (Comparative example 1), 0.39 sec·W/cm² (Comparative example 2), 0.58 sec·W/cm² (Comparative example 3), 0.78 sec·W/cm² (Examples 1 and 3), and 0.97 sec·W/cm² (Examples 2 and 4), respectively.

Subsequently, an electric resistance layer was formed on the copper foil while applying oxygen as a reactive gas using a sputtering target including 4 at % of nickel (Ni), 60 at % of chromium (Cr), 18 at % of silicon (Si), and 18 at % of oxygen (O). In Examples 3 and 4, a liquid primer was further applied onto the electric resistance layer so as to have an average coating thickness of 5 μm, and dried to form a thermoplastic resin. An epoxy substrate (prepreg: R-1661, manufactured by Panasonic Corporation) in which the glass cloth was embedded in the epoxy resin was bonded onto each of the electric resistance layers of Examples 1 to 2 and Comparative examples 1 to 3 or each of the thermoplastic resin layers of Examples 3 and 4 by thermocompression bonding. The peel strength was measured by the peel test based on the IPC specification (IPC-TM-650). The results are shown in Tables 1.

TABLE 1

| | | | Surface treatment conditions | | | Electric | | | |
|---|---|---|---|---|---|---|---|---|---|
| | | Line | IB | IB | Beam | resistance layer | | Evaluation results | |
| | Roughness | speed | voltage | current | intensity | Sputtering | Alloy | Peel strength | |
| | (Rz)[μm]) | [m/min] | [V] | [mA] | [sec·W/cm²] | power [kW] | composition | [kN/m] | Peeled state |
| Comparative | 0.51 | 0.88 | 125 | 100 | 0.24 | 1.5 | NiCrSiO | Incapable | Occurrence of |
| example 1 | | | | | | | | measurement | peeling between the |
| | | | | | | | | | metal foil and the |
| | | | | | | | | | resistive layer |
| Comparative | 0.51 | 0.88 | 200 | 100 | 0.39 | 1.5 | NiCrSiO | Incapable | Occurrence of |
| example 2 | | | | | | | | measurement | peeling between the |
| | | | | | | | | | metal foil and the |
| | | | | | | | | | resistive layer |
| Comparative | 0.51 | 0.88 | 300 | 100 | 0.58 | 1.5 | NiCrSiO | Incapable | Occurrence of |
| example 3 | | | | | | | | measurement | peeling between the |
| | | | | | | | | | metal foil and the |
| | | | | | | | | | resistive layer |
| Example 1 | 0.51 | 0.88 | 400 | 100 | 0.78 | 1.5 | NiCrSiO | 0.53 | Normal peeling |
| | | | | | | | | | (between the |
| | | | | | | | | | resistive layer and |
| | | | | | | | | | the substrate) |
| Example 2 | 0.51 | 0.88 | 500 | 100 | 0.97 | 1.5 | NiCrSiO | 0.51 | Normal peeling |
| | | | | | | | | | (between the |
| | | | | | | | | | resistive layer and |
| | | | | | | | | | the substrate) |
| Example 3 | 0.51 | 0.88 | 400 | 100 | 0.78 | 1.5 | NiCrSiO | 1.29 | Normal peeling |
| | | | | | | | | | (between the |
| | | | | | | | | | resistive layer and |
| | | | | | | | | | the substrate) |
| Example 4 | 0.51 | 0.88 | 500 | 100 | 0.97 | 1.5 | NiCrSiO | 1.42 | Normal peeling |
| | | | | | | | | | (between the |
| | | | | | | | | | resistive layer and |
| | | | | | | | | | the substrate) |

As shown in Table 1, in Examples 1 to 4, peeling between the metal foil and the electric resistance layer was not caused, but peeling between the resistive layer and the substrate was caused. On the other hand, in Comparative examples 1 to 3, peeling between the metal foil and the electric resistance layer was caused, and the peel strength of the electric resistance layer could not be measured.

Influence of Oxygen Supply on Sheet Resistance Value of Electric Resistance Layer

An electrolytic copper foil having a thickness of 18 μm was used. The 10-point average roughness Rz measured by the optical method as to the surface (roughened surface) of the metal foil was 0.8 μm. The electrolytic copper foil was placed in a vacuum chamber of the above sputtering device (14-inch metalyzer, manufactured by CHA) and conveyed at a line speed of 0.88 m/min. First, the entire surface of the copper foil was subjected to surface treatment (cleaning treatment) at an IB voltage of 400 V and an IB current of 100 mA. The ion beam intensity was 0.73 sec·W/cm² in both cases.

After the surface treatment, sputtering was performed at a sputtering power of 2.8 kW for 38 seconds using a sputtering target with an atomic percent ratio of Ni/Cr/SiO=4/60/36. In this case, an argon gas was used as an atmospheric gas, and oxygen as a reactive gas was introduced into a vacuum chamber under the conditions shown in Table 2. The pressure in the chamber was adjusted to around 5×10⁻³ Toll (total gas supply: about 75 sccm). An electric resistance layer including NiCrSiO with an oxygen concentration of 15 to 68 at % was formed on the electrolytic copper foil.

TABLE 2

| | Amount | Ratio of | Concentration | | |
|---|---|---|---|---|---|
| | of | oxygen | of oxygen in | | Visibility of |
| | oxygen | in a gas | the resistive | Resistance | the resistive |
| | sccm | vol % | layer at % | value Ω/sq | layer |
| Com- | 0 | 0 | 15 | 1048 | OK |
| parative | | | | | |
| example 4 | | | | | |
| Example 5 | 6 | 8.0 | 31 | 2305 | OK |
| Example 6 | 8 | 10.7 | 34 | 2941 | OK |
| Example 7 | 10 | 13.3 | 39 | 6308 | OK |
| Example 8 | 14 | 18.7 | 50 | 10375 | OK |
| Example 9 | 20 | 26.7 | 68 | 12217 | NG |
| | | | | | (vitrification) |

As shown in Table 2, when the oxygen concentration in the electric resistance layer was 20 at % or less (Comparative example 4), the resistance value was not sufficiently improved. When the oxygen concentration in the electric resistance layer was from 20 to 60 at % (Examples 5 to 8), the sheet resistance value was increased as the oxygen concentration was increased. When the oxygen concentration in the electric resistance layer was 68 at% (Example 9), the resistive layer was vitrified.

Influence of Change in Resistance Values of Electric Resistance Layers Before and After Soldering Flow

The electrolytic copper foil, with a thickness of 18 μm and a 10-point average roughness Rz of 0.51 μm, formed by the same method as the electrolytic copper foil of Example 1 was subjected to surface treatment at a line speed of 0.88 m/min and an ion beam intensity of 0.73 sec·W/cm². Then, sputtering was performed at sputtering powers shown in Table 3 using a sputtering target with an atomic percent ratio of Ni/Cr/SiO=4/60/36. In this case, an argon gas was used as an atmospheric gas, oxygen as a reactive gas was introduced into a vacuum chamber under the conditions shown in Table 3, and the pressure in the chamber was adjusted to around 5×10⁻³ Toll (total gas supply: 75 sccm) to produce electric resistance layers, those of which were designated as Comparative example 5 and Examples 10 and 11. Subsequently, Comparative example 5 and Examples 10 and 11 were stacked to epoxy resin substrates through the above-described liquid primer to form single-sided boards. Thereafter, resistive elements were produced by etching, and the electric resistance values before and after the soldering reflow of the obtained resistive elements were measured. The results are shown in Tables 3.

TABLE 3

| | | | Change in resistance value | | |
|---|---|---|---|---|---|
| | | | after soldering reflow | | |
| | | Ratio of | Before | After | |
| | Sputtering | oxygen in | treatment | reflow | Change |
| | power kW | a gas vol % | ohm | ohm | rate % |
| Comparative | 1.4 | 0 | 984 | 1025 | 4.0 |
| example 5 | | | | | |
| Example 10 | 2.8 | 6 | 881 | 885 | 0.5 |
| Example 11 | 1.4 | 12 | 3651 | 3660 | 0.2 |

As shown in Table 3, the electric resistance layers of Examples 10 and 11 to which O₂ was applied at the time of spattering had a smaller change rate of the resistance values before and after the soldering flow as compared with that of Comparative example 5 to which O₂ was not applied at the time of spattering.

1. A method for producing a metal foil with an electric resistance layer comprising forming an electric resistance layer on a metal foil having a 10-point average roughness Rz, which is measured by the optical method according to 1 μm or less and whose surface is treated by irradiation with ion beams at an ion beam intensity of 0.70 sec·W/cm² to 2.10 sec·W/cm² by vapor deposition while applying oxygen as an atmospheric gas using a sputtering target containing nickel, chromium, and silicon.

2. The method according to claim 1, wherein the forming an electric resistance layer includes controlling the amount of oxygen as an atmospheric gas so that the oxygen concentration in the electric resistance layer is from 20 at % to 60 at %.

3. The method according to claim 1, wherein the sputtering target comprises NiCrSi alloy or NiCrSiO alloy.

4. The method according to claim 1, wherein the sputtering target has a Ni-content from 2 at % to 10 at %, a Cr-content from 73 at % to 79 at % and an O-content from 10 at % to 60 at % in a component percentage of Cr and Si (Cr/(Cr+Si)×100[%]).

5. The method according to claim 4, wherein the applying oxygen as an atmospheric gas includes applying 0 vol % to 19 vol % of oxygen as the atmospheric gas.

6. The method according to claim 1, further comprising providing a thermoplastic resin layer on the electric resistance layer.

7. The method according to claim 1, wherein the metal foil comprises an electrolytic copper foil or a rolled copper foil.
